(19) United States
(12) Patent Application Publication
(10) Pub. No.: US 2005/0202856 A1
(43) Pub. Date: Sep. 15, 2005

(54) Swing-type portable terminal

(75) Inventors: Sung-Sun Park, Gumi-si (KR); Jong-Gun Bae, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/045,142

(22) Filed: Jan. 31, 2005

(30) Foreign Application Priority Data
Mar. 12, 2004 (KR) 2004-16832

(51) Int. Cl. H01H 21/78

(52) U.S. Cl. 455/575.1; 348/374

(57) ABSTRACT

A swing-type portable terminal includes a first housing having a reception space surrounded by a top surface, a bottom surface, and a lateral wall connecting a portion of the top surface to a portion of the bottom surface. A second housing is adapted to rotate about a hinge axis extending perpendicularly to the top surface of the first housing and is adapted to be received in or released from the reception space. A hinge device is positioned along the hinge axis for rotatably coupling the first and second housings to each other and provides an elastic force in a direction so that the second housing is released from the reception space.

### CROSS-REFERENCE TO RELATED APPLICATION

This application claims the benefit under 35 U.S.C. § 119(a) of Korean Patent Application No. 2004-16832, entitled “Swing-Type Portable Terminal,” filed on Mar. 12, 2004, the entire contents of which are hereby incorporated by reference.

### BACKGROUND OF THE INVENTION

1. Field of the Invention

The present invention relates to a portable terminal. More particularly, the present invention relates to a swing-type portable terminal having a pair of housings rotatably coupled to one another and facing each other.

2. Description of the Related Art

Portable terminals are used to connect users with service providers or with other users via base stations in a wireless manner for providing communication services. Portable terminals may be classified into bar-type terminals, flip-type terminals, and folder-type terminals according to their appearance.

Bar-type terminals have a single body housing, on which data input/output means and transmitter/receiver units are positioned. A problem with bar-type terminals is that their keypads are used as a data input means. Therefore, the keypads are always exposed and are prone to accidental operation. In addition, there exists a limitation in reducing the size of bar-type terminals, because a minimum distance must be maintained between the transmitter and receiver units of the terminals.

Flip-type terminals have a body, a flip portion, and a hinge module for connecting the body with the flip portion. The body has data input/output means and transmitter/receiver units positioned thereon. The flip portion is adapted to cover the keypad, which is used as the data input means. Thus, erroneous operation thereof can be avoided. However, there still exists a limitation in making the flip-type terminals compact, because a minimum distance must be maintained between the transmitter and receiver units of the terminals.

The folder-type terminals have a body, a folder, and a hinge module for connecting the body with the folder so that the folder can rotate in a direction towards or away from the body between open/closed positions. During a standby mode, the folder is folded on the body to avoid any erroneous operation of the keypad. During a speech mode, the folder is unfolded to secure a sufficient distance between the transmitter and receiver units. The hinge module of the flip-type or folder-type terminals, which couples the flip or folder to the body in such a manner that it can rotate, typically exerts a force in such a direction that the flip or the folder is automatically opened without any additional application of force from a user.

Recently, users' tastes in choosing portable terminals have been diversified and their demands for information have increased. However, current research and development on portable terminals has not met such recent trends.

Accordingly, there is a need for an improved swing-type portable terminal for providing communications services.

### SUMMARY OF THE INVENTION

An aspect of the present invention is to provide a swing-type portable terminal having a pair of rotatably coupled housings adapted for opening or closing the terminal.

Another object of the present invention is to provide a swing-type portable terminal having a pair of housings rotatably coupled to each other by a hinge device so that each housing can rotate while facing each other.

The foregoing and other objects and advantages are substantially realized by providing a swing-type portable terminal including a first housing providing a reception space surrounded by a top surface, a bottom surface, and a lateral wall connecting a portion of the top surface to a portion of the bottom surface. A second housing is adapted to rotate about a hinge axis extending perpendicularly to the upper surface of the first housing, and being adapted to be received in or released from the reception space. A hinge device is positioned along the hinge axis for rotatably coupling the first and second housings to each other, and for providing an elastic force in such a direction that the second housing is released from the reception space.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a swing-type portable terminal in accordance with an embodiment of the present invention;

FIG. 2 is a perspective view showing the portable terminal shown in FIG. 1 from another direction;

FIG. 3 is a perspective view showing the portable terminal shown in FIG. 1 with the second housing open;

FIG. 4 is a perspective view showing the portable terminal shown in FIG. 3 from another direction;

FIG. 5 is an exploded perspective view showing the portable terminal shown in FIG. 1;

FIG. 6 is a perspective view showing the internal configuration of the portable terminal shown in FIG. 1;

FIG. 7 is a perspective view showing the internal configuration of the portable terminal shown in FIG. 1 with the second housing open; and

FIG. 8 is an exploded perspective view showing a locking device of the portable terminal shown in FIG. 1.

Throughout the drawings, the same drawing reference numerals will be understood to refer to the same elements, features, and structures.

### DETAILED DESCRIPTION OF THE EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications to the embodiments described herein can be made without departing from the scope and spirit of the invention. Also, descriptions of well-known functions or constructions are omitted for conciseness.

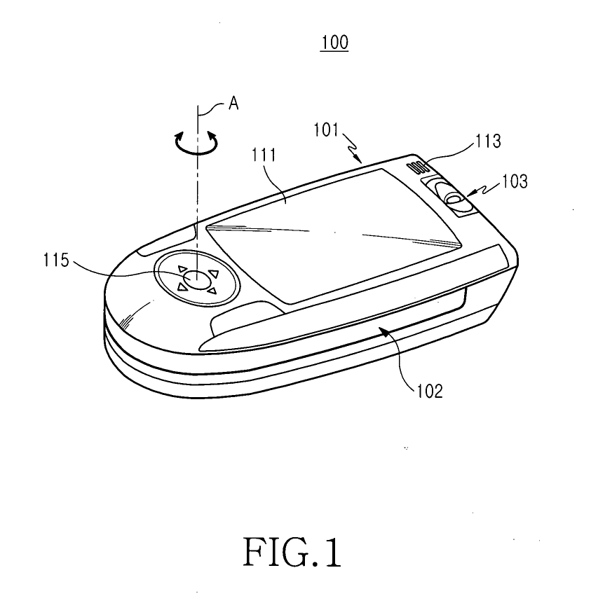

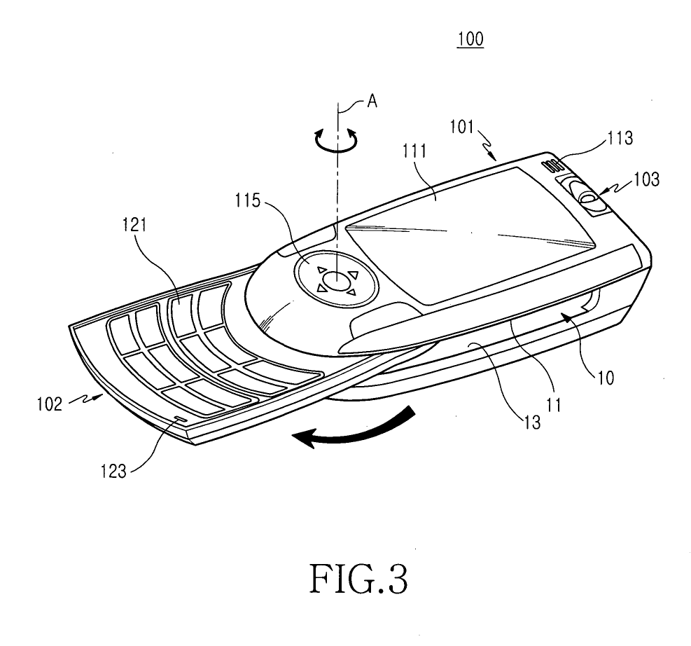

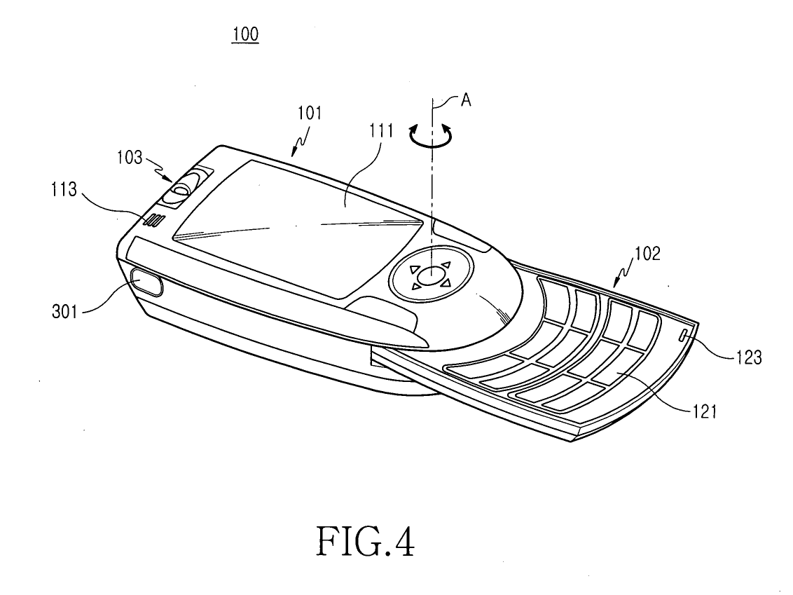

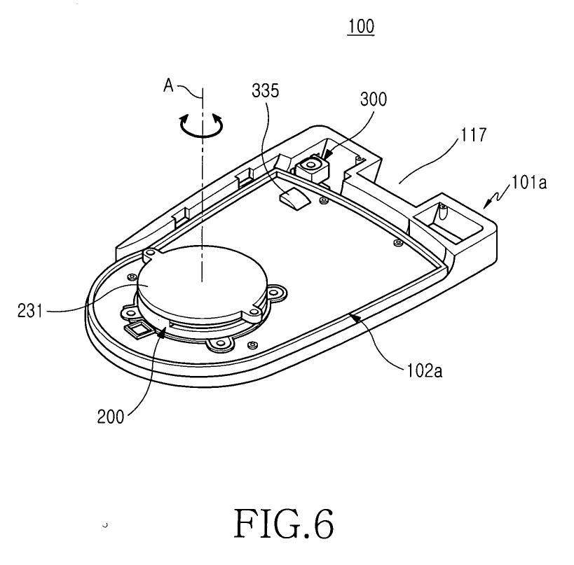

Referring to FIGS. 1-4, a portable terminal 100 according to an exemplary embodiment of the present invention includes a first housing 101 and a second housing 102. The housings 101, 102 are rotatably coupled to one another by a hinge device 200 (shown in FIG. 6) in such a manner that each housing can rotate while facing one another. The second housing 102 is received in a reception space 10 formed in the first housing 101.

The first housing 101 has a display device 111 and a receiver unit 113 positioned on the upper surface thereof. A keypad 115, including a navigation key, is positioned next to a side of the display device 111. The first housing 101 has a rotation hole 117 (shown in FIG. 6) formed on the upper end thereof, to which a substantially cylindrical camera lens assembly 103 is rotatably coupled.

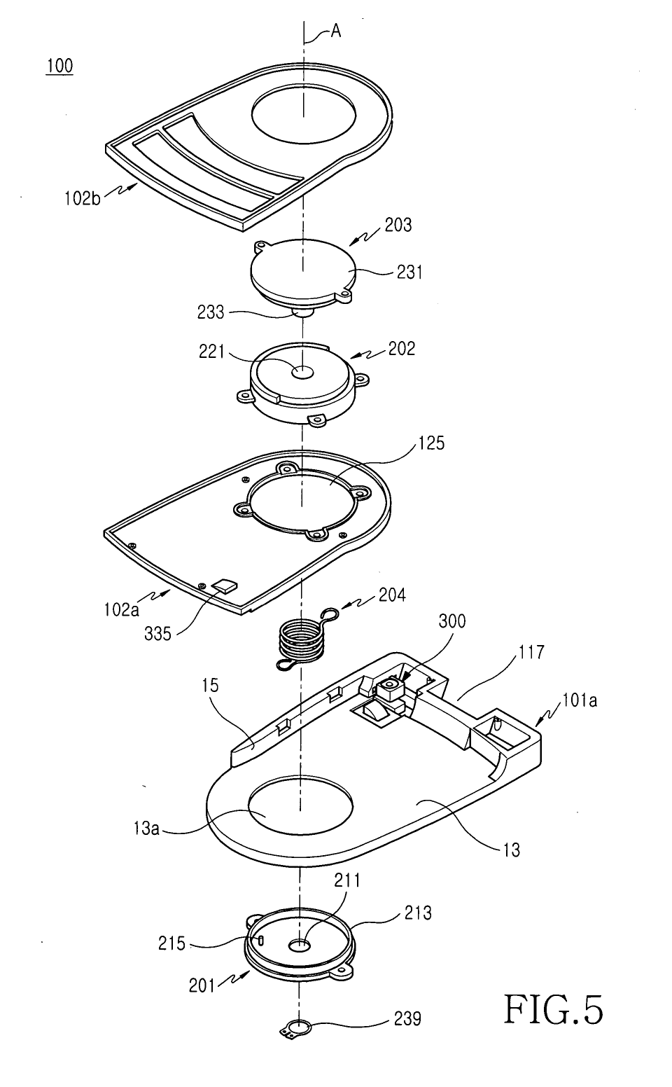

The first housing 101 reception space 10 is positioned between the upper and lower surfaces thereof and receives the second housing 102. The reception space 10 opens to a lateral surface of the first housing 101. The reception space 10 is surrounded by a top surface 11, a bottom surface 13, and a lateral wall 15 (shown in FIG. 5) positioned adjacently to the other lateral surface of the first housing 101.

The second housing 102 is adapted to rotate about hinge axis A into and out of the reception space 10. Hinge axis A extends perpendicular to the upper surface of the first housing 101. The second housing 102 has a keypad 121 positioned on the upper surface thereof for inputting numerals and characters. The key buttons are preferably arranged in a 3×4 array. As the second housing 102 rotates 180° from a position in which it is received in the first housing 101, the keypad 121 is completely exposed. The second housing 102 has a transmitter unit 123 positioned on a side of the keypad 121, adjacent to the lower end of the second housing 102. When the second housing 102 rotates 180° from the reception space 10, maximum spacing is secured between the receiver unit 113 and the transmitter unit 123.

Referring to FIGS. 5-7, the hinge device 200 rotatably couples the first housing 101 and second housing 102. The hinge device 200 includes a first hinge base 201, a second hinge base 202, a hinge coupler 203, and a torsion coil spring 204.

The first hinge base 201 is fixed to the inner peripheral surface of a first housing case 101a. The first hinge base 201 is exposed to the reception space 10 through a first through-hole 13a formed in the bottom surface 13 of the housing case 101a. The first hinge base 201 is substantially circular and is provided with a through-hole 211 through which hinge axis A passes.

The second hinge base 202 is fixed to the interior of a lower case 102a. The second hinge base 202 extends through a second through-hole 125 formed on the lower surface of the second hinge base 202. The second hinge base 202 is substantially circular and is provided with a through-hole 221 through which the hinge axis A passes. The first and second through-holes 13a and 125 are positioned along the hinge axis A so that the first and second hinge bases 201 and 202 face each other.

The first and second hinge bases 201, 202 are rotatably coupled to each other by the hinge coupler 203.

The hinge coupler 203 has a substantially circular coupling plate 231 coupled to the upper end of the second hinge base 202 and a coupling shaft 233 extending from a surface of the coupling plate 231. The coupling shaft 233 extends through through-holes 211, 221 formed in the first and second hinge bases 201 and 202, respectively, for rotatably coupling the first and second hinge bases 201 and 202 to one another. An end of coupling shaft 233 extends through the through-hole 211 of the first hinge base 201 and is positioned on the interior of the first housing 101. A snap ring 239 is fastened to the end of the coupling shaft 233. Snap ring 239 is positioned on the interior of the first housing 101 and prevents the hinge coupler 203 from being released from the first and second hinge bases 201 and 202.

The first hinge base 201 has a guide rib 213 formed on a surface thereof, the guide rib 213 extends in a circumferential direction. The guide rib 213 is coupled to and faces the inner peripheral surface of the lower end of the second hinge base 202, and guides the rotation of the second housing 102.

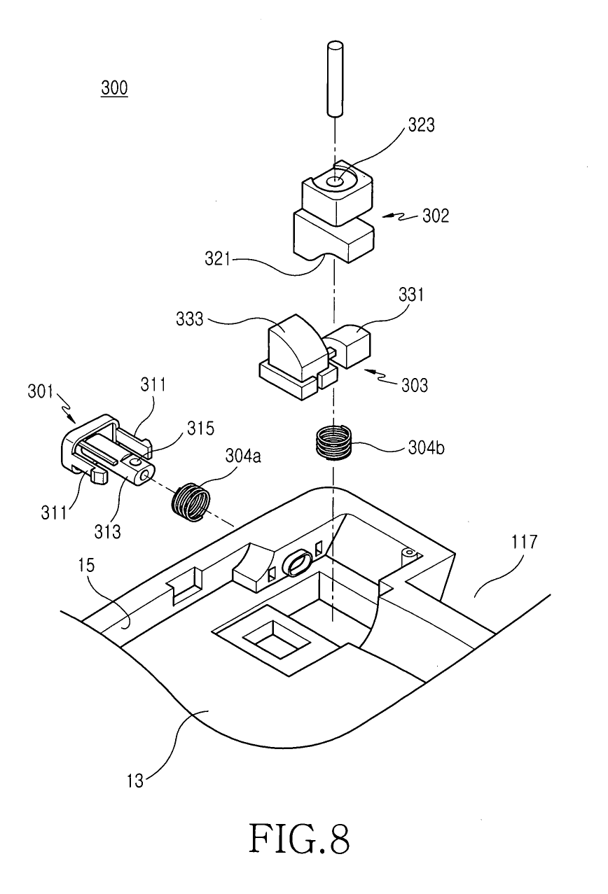

The torsion coil spring 204 provides an elastic force in a direction so that second housing 102 is urged from the reception space 10. The torsion coil spring 204 is positioned inside the second hinge base 202. A first end of the torsion coil spring 204 is fixed to a fixation protrusion 215 formed on the first hinge base 201, and the other end is fixed to a fixation protrusion (not shown) formed on the interior of the second hinge base 202. The torsion coil spring 204 accumulates an elastic force when the second housing 102 is positioned in the reception space 10. As seen in FIGS. 5-8, a locking device 300 is illustrated for facilitating positioning of second housing 102 in the reception space 10. The locking device 300 includes an operation button 301, a driving body 302, a following body 303, and coil springs 304a, 304b.

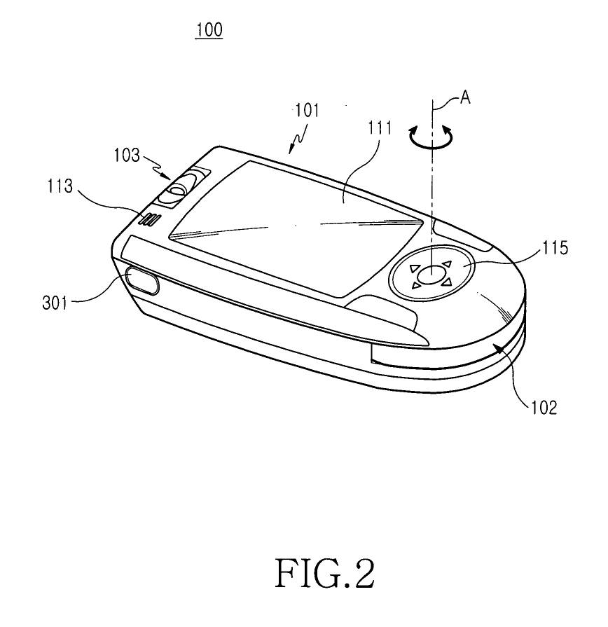

Referring to FIGS. 2-4, the operation button 301 is positioned on the lateral wall of the first housing 101 of the portable terminal 100. The operation button 301 is depressed for initiating rotation of the second housing 102. A first coil spring 304a is positioned between the inner surface of the operation button 301 and the outer wall of the first housing 101. The first coil spring 304a provides an elastic force in a direction such that the operation button 301 protrudes to the outer peripheral surface of the first housing 101. The operation button 301 has a pair of guide hooks 311 and an operation shaft 315 extending from the inner surface thereof, respectively.

The guide hooks 311 extend from both ends of the inner surface of the operation button 301, while facing each other. The guide hooks 311 are coupled to the first housing 101 in such a manner that they can reciprocate linearly. In order to prevent the operation button 301 from being operated accidentally, the outer peripheral surface of the operation button 301 preferably does not protrude beyond a surface of the first housing 101 even when an elastic force is applied to the operation button 301. Therefore, the operation 301 button appears substantially flush with a surface of the first housing 301. Specifically, although the operation button 301 is adapted to appear flush with and recede from the first housing 101, it preferably is configured so that in practice it does not protrude to the outer peripheral surface of the first housing 101. The operation shaft 313 extends parallel to and between the pair of guide hooks 311 with an end fixed to the driving body 302.

The driving body 302 has a first cam 321 formed on the lower end thereof in a predetermined curved surface shape. A fixation hole 323 is formed on the upper end thereof. The operation shaft 313 is inserted into and fixed to the upper portion of a lateral surface of the driving body 302. The operation shaft 313 has a pin hole 315 aligned in a straight line with the fixation hole 323 of the driving body 302. A fixation pin is coupled to the fixation hole 323 and the pin hole 315. If the user depresses the operation button 301, the driving body 302 travels linearly in the horizontal direction in response. If the pressure on the operation button 301 from the user is removed, the elastic force from the first coil spring 304a causes the operation button 301 and the operation shaft 313 to retract, and the driving body 302 to linearly travel together with them.

The following body 303 is provided with a second cam 331 having a curved surface shape corresponding to that of the first cam 321 of the driving body 302. If the user depresses the operation button 301 and the driving body 302 travels linearly, the following body 303 linearly travels in the vertical downward direction due to the curved surface shape of the first and second cams 321, 331. The following body 303 has a second coil spring 304b positioned on the lower portion thereof. The second coil spring 304b provides an elastic force in a direction such that the second cam 331 is forced against the first cam 321.

If the user depresses the operation button 301, the driving and following bodies 302 and 303 travel in the horizontal and vertical directions, respectively. In addition, the coil springs 304a, 304b accumulate an elastic force. If the pressure on the operation button 301 from the user is removed, the elastic force from the first coil spring 304a causes the operation button 301 to retract to the initial position. The elastic force from the second coil spring 304b causes the following body 303 to travel in such a direction that the first and second cams 321, 331 are forced against each other.

The following body 303 has a locking protrusion 333 positioned on a side of the second cam 331. The locking protrusion 333 is adapted to extend into and out of the reception space 10 of the first housing 101. The locking protrusion 333 protrudes to the bottom surface 13 by means of the elastic force from the second coil spring 304b and temporarily travels in the vertical downward direction when the operation button 301 is depressed by the user or when the second housing 302 rotates in such a direction that it is received in the reception space 10.

The second housing 102 has a locking groove 335 formed on the lower surface thereof to engage with the locking protrusion 333. The lower surface of the locking groove 335 is recessed to engage with the locking protrusion 333. As the second housing 102 is completely received in the reception space 10, the locking protrusion 333 and the locking groove 335 engage with each other and prevent the second housing 102 from being released from the reception space 10.

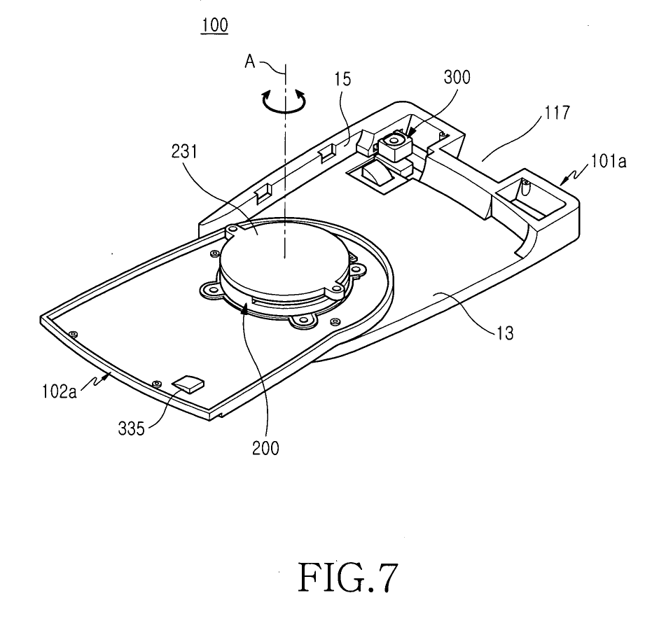

Referring to FIG. 6, the locking protrusion 333 and the locking groove 335 engage with each other when the second housing 102 is received in the reception space 10. If the operation button 301 is depressed by the user, the driving and following bodies 302 and 303 linearly travel and the locking protrusion 333 escapes from the locking groove 335. In addition, the elastic force from the hinge device 200 urges the second housing 102 to rotate and to be released from the reception space 10 as shown in FIG. 7.

As mentioned above, the present invention provides a swing-type portable terminal having a pair of housings coupled to each other in such a manner that they can rotate while facing each other and one housing can be received in the other housing, in order to meet diversified tastes of users. In addition, the terminal is convenient to carry because one housing can be received in the other housing and is convenient to use because the received housing can be unfold by simply pressing the operation button.

While the invention has been shown and described with reference to certain preferred embodiments thereof, it will be understood by those skilled in the art that various changes in form and details may be made therein without departing from the spirit and scope of the invention as defined by the appended claims.

1. A swing-type portable terminal comprising:
a first housing having a top surface, a bottom surface, and a lateral wall connecting a portion of the top surface to a portion of the bottom surface, the top and bottom surfaces and the lateral wall defining a reception space;
a second housing adapted to rotate about a hinge axis extending perpendicularly to the top surface of the first housing, and adapted to be received in or released from the reception space; and
a hinge device being positionable about the hinge axis for rotatably coupling the first and second housings to each other, and for providing an elastic force in such a direction that the second housing is released from the reception space.

2. A swing-type portable terminal as claimed in claim 1, wherein
the second housing is rotatable about 180°.

3. A swing-type portable terminal as claimed in claim 1, wherein
the second housing is rotatable about 180° from a received position in the reception space to a released position.

4. A swing-type portable terminal as claimed in claim 1, wherein
the first housing has a keypad and a display device positioned on the upper surface.

5. A swing-type portable terminal as claimed in claim 1, wherein
the first housing has a keypad including a navigation key.

6. A swing-type portable terminal as claimed in claim 1, wherein
the first housing comprises a rotation hole having a camera lens rotatably coupled therein.

7. A swing-type portable terminal as claimed in claim 1, wherein
the second housing has a keypad positioned on the upper surface thereof, and the keypad comprises a number of key buttons adapted to input numerals and characters.

8. A swing-type portable terminal as claimed in claim 1, further comprising
a receiver unit being positioned adjacent to an upper end of the first housing and a transmitter unit being positioned adjacent to a lower end of the second housing.

9. A swing-type portable terminal as claimed in claim 1, further comprising
a locking device comprising an operation button adapted to appear substantially flush with a surface of the first housing, and adapted to recede from the surface of the first housing when depressed, movement of the operation button being facilitated by a predetermined elastic force;
a driving body has a first cam formed on an end thereof in a predetermined curved surface shape, and is adapted to linearly reciprocate in the horizontal direction as the operation button is depressed and released; and
a following body having a second cam formed in a curved surface shape corresponding to that of the first cam of the driving body for linearly reciprocating in the vertical direction as the driving body reciprocates linearly, and a locking protrusion formed on an end thereof to protrude and retract from the bottom surface of the reception space, and wherein
the second housing has a locking groove formed on the lower surface thereof which faces the bottom surface of the reception space to engage with the locking protrusion, so that when the second housing is received in the reception space, the locking protrusion and the locking groove engage with each other.

10. A swing-type portable terminal as claimed in claim 9, further comprising
a coil spring interposed between the inner surface of the operation button and the lateral surface of the first housing for providing an elastic force in such a direction that the operation button protrudes to the lateral surface of the first housing.

11. A swing-type portable terminal as claimed in claim 10, further comprising
an operation shaft extending from the inner surface of the operation button adapted to be inserted into a lateral surface of the driving body, and wherein the operation shaft and the driving body are fixed to each other by a fixation pin.

12. A swing-type portable terminal as claimed in claim 10, further comprising
a coil spring supported on the inner peripheral surface of the first housing and adapted to act in a direction so that the locking protrusion protrudes to the bottom surface of the reception space.

13. A swing-type portable terminal as claimed in claim 1, wherein the hinge device further comprising
a first hinge base being coupled to the inner peripheral surface of the first housing and exposed through a first through-hole formed on the bottom surface of the reception space;
a second hinge base being coupled to the inner peripheral surface of the second housing and exposed through a second through-hole formed on the bottom surface of the second housing to face the first hinge base;
a hinge coupler having a coupling shaft coupled to an end of the second hinge base, and extending through the first hinge base for coupling along the hinge axis, so that the first and second hinge bases are rotatably coupled to each other; and
a torsion coil spring interposed between the first and second hinge bases with an end fixed to the first hinge base and the other end fixed to the second hinge base for providing an elastic force in such a direction that the second housing is released from the reception space.

14. A swing-type portable terminal as claimed in claim 13, wherein
a snap ring is coupled to an end of the coupling shaft, and extends through the first hinge base for preventing the hinge coupler from being released.

15. A swing-type portable terminal as claimed in claim 13, wherein
the second hinge base is substantially cylindrical, and extends a predetermined distance along the hinge axis, and the torsion coil spring is received in the second hinge base.
